(19) United States
(12) Patent Application Publication
(10) Pub. No.: US 2025/0316967 A1
(43) Pub. Date: Oct. 9, 2025

(54) WATER STOP MATERIAL FILLING METHOD AND ELECTRIC JUNCTION BOX

(71) Applicant: YAZAKI CORPORATION, Tokyo (JP)

(72) Inventor: Hikaru Kinoshita, Kosai-shi (JP)

(21) Appl. No.: 19/072,964

(22) Filed: Mar. 6, 2025

(30) Foreign Application Priority Data
Apr. 8, 2024 (JP) 2024-062084

(51) Int. Cl. H02G 3/08; B29C 70/68; B29C 70/72; B29C 70/88; B29L 31/34

(52) U.S. Cl. CPC H02G 3/088; B29C 70/682; B29C 70/72; B29C 70/88; B29K 2995/0069; B29L 2031/3481

(57) ABSTRACT

A water stop material filling method for filling a water stop material into an outlet of an electric wire provided in an electric junction box, the water stop material filling method includes pouring the water stop material through a first hole that is formed in a hollow filling portion surrounding an outside of the outlet and communicating with the outlet.

### CROSS-REFERENCE TO RELATED APPLICATIONS

This application is based on and claims priority under 35 USC 119 from Japanese Patent Application No. 2024-062084 filed on Apr. 8, 2024, the entire content of which is incorporated herein by reference.

### TECHNICAL FIELD

The present disclosure relates to a water stop material injecting method and an electric junction box.

### BACKGROUND ART

In the related art, an electric junction box (also referred to as a junction box, a fuse box, a relay box, or the like) that is mounted on a vehicle such as an automobile and that collectively accommodates electronic components such as a wire harness, a fuse, and a relay therein is known. Such an electric junction box has an outlet through which a wire harness electrically connected to the electronic component accommodated in the electric junction box is drawn out to the outside.

In order to prevent water from entering the electric junction box through the outlet described above, a technique in JP H03-220795A has been proposed. JP H03-220795A describes filling the inside of the outlet with a waterproof silicone resin (a water stop material).

However, in the electric junction box, a hole or a cutout through which a binding band passes may be formed in the outlet, and the electric junction box may be fixed to the outlet by the binding band. In this case, there is only a small gap between an electric wire and the inner wall of the outlet to which the electric wire is fixed. Therefore, it is impossible to fill the small gap described above with the waterproof silicone resin, resulting in a problem of being unable to achieve waterproofing.

The present disclosure has been made in view of the circumstances described above, and an object of the present disclosure is to provide a water stop material filling method and an electric junction box that can improve the waterproofness even when the gap between an outlet and an electric wire is small.

### SUMMARY OF INVENTION

In order to achieve the object described above, the water stop material filling method according to the present disclosure is characterized as follows.

A water stop material filling method for filling a water stop material into an outlet of an electric wire provided in an electric junction box, the water stop material filling method includes pouring the water stop material through a first hole that is formed in a hollow filling portion surrounding an outside of the outlet and communicating with the outlet.

In order to achieve the object described above, the electric junction box according to the present disclosure is characterized as follows.

An electric junction box includes an electric junction box body configured to accommodate an electronic component, an outlet through which an electric wire connected to the electronic component is pulled out from the electric junction box body, a hollow filling portion that surrounds an outside of the outlet and that communicates with the outlet, and a water stop material that is filled in the filling portion and a portion of the outlet surrounded by the filling portion. The filling portion is formed with a first hole through which the water stop material is poured.

In order to achieve the object described above, the electric junction box according to the present disclosure is characterized as follows.

An electric junction box includes an electric junction box body configured to accommodate an electronic component, and an outlet through which an electric wire connected to the electronic component is pulled out from the electric junction box body. The outlet is provided with a fixing portion to which the electric wire is fixed by a binding band. The electric junction box further includes a water stop material filled in the outlet on a side that is farther from a distal end of the outlet than is the fixing portion, and a second hole that is formed at the outlet and through which the water stop material is poured.

In order to achieve the object described above, the electric junction box according to the present disclosure is characterized as follows.

An electric junction box includes an electric junction box body configured to accommodate an electronic component, an outlet through which an electric wire connected to the electronic component is pulled out from the electric junction box body, and a water stop material that surrounds a distal end of the outlet and the electric wire pulled out from the distal end.

According to the water stop material filling method in the present disclosure, it is possible to improve the waterproofness even when the gap between an outlet and an electric wire is small.

The present disclosure has been briefly described above. Further, the details of the present disclosure can be clarified by reading a mode (hereinafter, referred to as an “embodiment”) for carrying out the disclosure to be described below with reference to the accompanying drawings.

### BRIEF DESCRIPTION OF DRAWINGS

FIG. 1 is a side view of an electric junction box according to a first embodiment;

FIG. 2 is a side view of an outlet of the electric junction box shown in FIG. 1;

FIG. 3 is a view taken along an arrow A in FIG. 2;

FIG. 4 is a view taken along an arrow B in FIG. 2;

FIG. 5 is a cross-sectional view taken along a line C-C in FIG. 3;

FIG. 6 is a top view of an outlet constituting an electric junction box according to a second embodiment;

FIG. 7 is a cross-sectional view taken along a line D-D in FIG. 6;

FIGS. 8A and 8B are views showing a water stop material filling method for filling the outlet of the electric junction box shown in FIG. 6 with a water stop material;

FIG. 9 is a side view of an outlet constituting an electric junction box according to a third embodiment;

FIG. 10 is a view taken along an arrow E in FIG. 9;

FIG. 11 is a cross-sectional view taken along a line F-F in FIG. 10;

FIGS. 12A and 12B are views showing a water stop material filling method for filling the outlet of the electric junction box shown in FIG. 9 with a water stop material;

FIG. 13 is a view showing a water stop material filling method according to a fourth embodiment;

FIG. 14 shows an example of a closing member shown in FIG. 13;

FIG. 15 shows an example of the closing member shown in FIG. 13; and

FIG. 16 shows an example of the closing member shown in FIG. 13.

### DESCRIPTION OF EMBODIMENTS

Specific embodiments of the present disclosure will be described below with reference to the drawings.

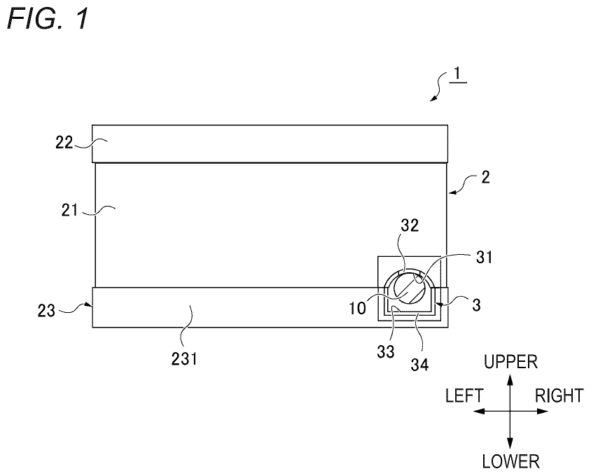

Hereinafter, for convenience of description, as shown in FIGS. 1 to 16, “front”, “rear”, “left”, “right”, “upper”, and “lower” are defined. The “front-rear direction”, the “left-right direction”, and the “upper-lower direction” are orthogonal to one another.

### First Embodiment

First, an electric junction box 1 according to a first embodiment will be described. As shown in FIG. 1, the electric junction box 1 according to the first embodiment includes an electric junction box body 2 that accommodates an electronic component (not shown), and an outlet 3 through which a wire harness (an electric wire) 10 connected to the electronic component is pulled out from the electric junction box body 2.

The electric junction box body 2 according to the present embodiment includes a block (not shown) on which the electronic component is mounted, a frame 21 that accommodates the block, an upper cover 22, and a lower cover 23. The block, the frame 21, the upper cover 22, and the lower cover 23 are integrally molded from an insulating synthetic resin.

The frame 21 is provided in a substantially rectangular tubular shape having openings on the upper and lower sides. The upper cover 22 is attached to the frame 21 so as to close the upper opening of the frame 21. The lower cover 23 is attached to the frame 21 so as to close the lower opening of the frame 21.

The frame 21 is formed with a first cutout 31 that is formed by cutting out the lower end thereof, and a first outlet 32 that extends outward from the edge portion of the first cutout 31. The lower cover 23 includes a body wall (not shown) that closes the lower opening of the frame 21, and a standing wall 231 that stands upward (toward the frame) from the edge portion of the body wall.

The lower cover 23 is formed with a second cutout 33 that is formed by cutting out the upper end of the standing wall 231, and a second outlet 34 that extends outward from the edge portion of the second cutout 33. When the lower cover 23 is attached to the frame 21, the first outlet 32 and the second outlet 34 are aligned in the upper-lower direction to form the tubular outlet 3 through which the wire harness 10 is pulled out from the electric junction box body 2.

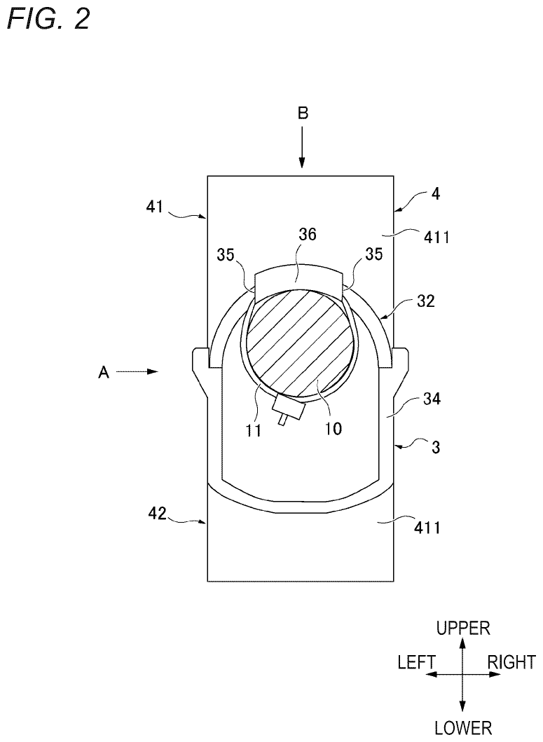

As shown in FIG. 2 and the like, the first outlet 32 is formed with, at the rear end thereof, a pair of cutouts 35 and 35 through which a binding band 11 to be described later passes. The pair of cutouts 35 and 35 are arranged side by side in the axial rotation direction of the wire harness 10. The first outlet 32 between the pair of cutouts 35 and 35 serves as a fixing portion 36 of the wire harness 10. The wire harness 10 that passes through the outlet 3 is fixed to this fixing portion 36 by the binding band 11.

As shown in FIGS. 2 to 4, the electric junction box 1 according to the present embodiment includes a hollow filling portion 4 that surrounds the outside of the outlet 3 and that communicates with the outlet 3. As shown in FIG. 5, the electric junction box 1 according to the present embodiment includes a water stop material 6 that is filled in the filling portion 4 and a portion of the outlet 3 surrounded by the filling portion 4.

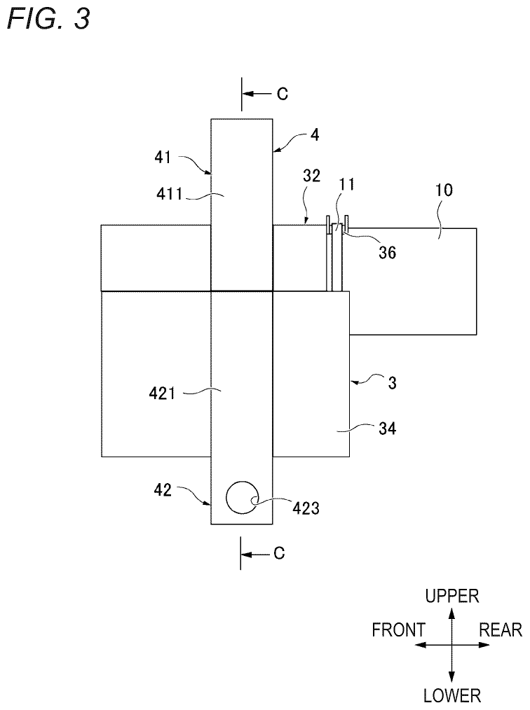

The filling portion 4 is integrally molded with the outlet 3 using the resin. As shown in FIGS. 3 to 5, the filling portion 4 includes a first filling portion 41 that is provided in front of the fixing portion 36 of the first outlet 32 (away from the distal end of the outlet 3), and a second filling portion 42 that is provided at the second outlet 33 and that faces the first filling portion 41 in the upper-lower direction. The first filling portion 41 includes a peripheral wall 411 that has a rectangular tubular shape and that stands upward from the front side with respect to the fixing portion 36 of the first outlet 32, and an upper wall 412 that closes the upper opening of the peripheral wall 411.

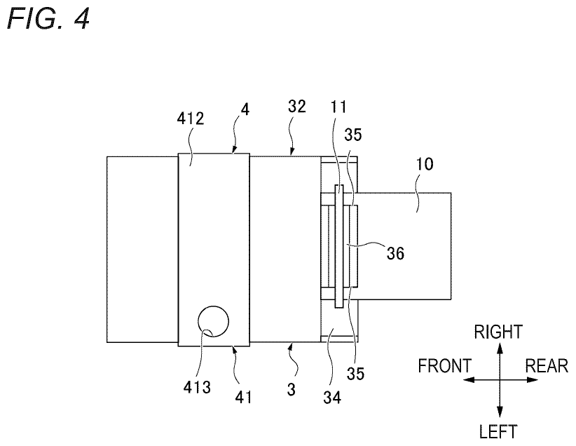

The peripheral wall 411 according to the present embodiment has a width substantially equal to the width of the first outlet 32 in the left-right direction, and protrudes upward beyond the first outlet 32. The first outlet 32 is formed with a communicating hole (not shown) at a portion facing the upper wall 412 in the upper-lower direction. The first filling portion 41 and the outlet 3 communicate with each other through this communicating hole. As shown in FIGS. 4 and 5, the upper wall 412 is formed with an inlet 413 as a first hole into which the water stop material 6 is poured. The inlet 413 penetrates the upper wall 412.

As shown in FIGS. 3 and 5, the second filling portion 42 includes a peripheral wall 421 that has a rectangular tubular shape and that stands downward from the second outlet 34, and a lower wall 422 that closes the lower opening of the peripheral wall 421. The peripheral wall 421 according to the present embodiment has a width substantially equal to the width of the second outlet 34 in the left-right direction, and protrudes downward beyond the second outlet 34. The second outlet 34 is formed with a communicating hole (not shown) at a portion facing the lower wall 422 in the upper-lower direction. The second filling portion 42 and the outlet 3 communicate with each other through this communicating hole. An outlet 423 through which the water stop material 6 is discharged is formed on the lower side of the peripheral wall 421. The outlet 423 penetrates the peripheral wall 421. When the lower cover 23 is attached to the frame 21, the lower end of the peripheral wall 411 and the upper end of the peripheral wall 421 are joined together.

The water stop material 6 is made of, for example, a foamed resin. As shown in FIG. 5, the water stop material 6 is filled in the filling portion 4 and the outlet 3 surrounded by the filling portion 4.

Next, a water stop material filling method for filling the outlet 3 of the electric junction box 1 with the water stop material 6 will be described. First, the operator pours the water stop material 6 through the inlet 413 formed in the first filling portion 41. The first filling portion 41 and the outlet 3 communicate with each other through a communicating hole. Therefore, the water stop material 6 enters the outlet 3 through the communicating hole. The second filling portion 42 and the outlet 3 communicate with each other through a communicating hole. Therefore, the water stop material 6 enters the second filling portion 42 through the communicating hole. When the filling portion 4 and the portion of the outlet 3 surrounded by the filling portion 4 are filled with the water stop material 6, the water stop material 6 comes out from the outlet 423. When the operator visually recognizes that the water stop material 6 comes out from the outlet 423, the operator stops pouring the water stop material 6. The foamed resin constituting the water stop material 6 hardens immediately when coming into contact with air. Therefore, the water stop material 6 does not flow to the electric junction box body 2 and the distal end of the outlet 3, but stays in the filling portion 4 and the outlet 3 surrounded by the filling portion 4.

As shown in FIG. 2, when the wire harness 10 is fixed to the fixing portion 36 of the outlet 3 and the gap between the wire harness 10 and the fixing portion 36 of the outlet 3 is small, the water stop material 6 cannot be filled in the small gap. According to the embodiment described above, the water stop material 6 is poured through the inlet 413 that is formed in the hollow filling portion 4 surrounding the outside of the outlet 3 and communicating with the outlet 3. Accordingly, as shown in FIG. 5, the water stop material 6 can be filled over the entire circumference of the wire harness 10, and the waterproofness can be improved.

### Second Embodiment

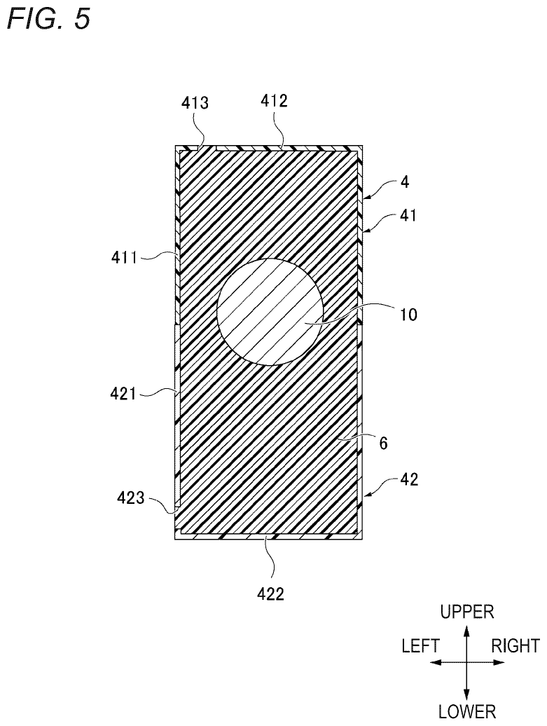

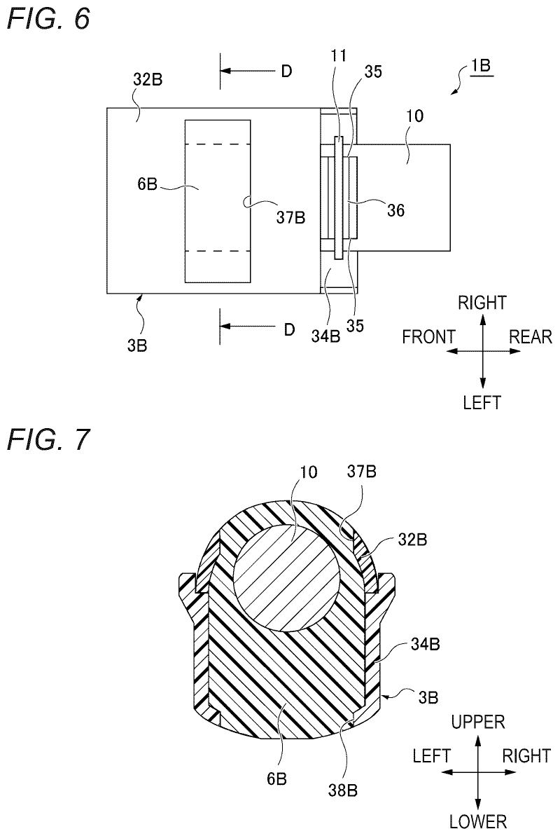

Next, an electric junction box 1B according to a second embodiment will be described with reference to FIGS. 6 to 8B. In FIGS. 6 to 8B, the same reference signs are given to the same parts as those of the electric junction box 1 already described in the first embodiment described above, and the detailed description thereof will be omitted. The electric junction box 1B according to the second embodiment includes the electric junction box body 2 (not shown in FIGS. 6 to 8B), an outlet 3B, and a water stop material 6B. A difference between the first embodiment and the second embodiment is that the filling portion 4 is not provided.

Since the electric junction box body 2 is the same as that in the first embodiment, the detailed description thereof is omitted here. As shown in FIGS. 6 and 7, the outlet 3B includes a first outlet 32B that is formed in the frame 21, and a second outlet 34B that is formed in the lower cover 23. Similarly to the first embodiment, the first outlet 32B is provided with the pair of cutouts 35 and the fixing portion 36. The wire harness 10 is fixed to the fixing portion 36 by the binding band 11.

In the second embodiment, as shown in FIG. 6, a communicating hole 37B serving as a second hole is formed in front of the fixing portion 36 of the first outlet 32B. As shown in FIG. 7, the second outlet 34B is formed with a communicating hole 38B facing the communicating hole 37B in the upper-lower direction. In the second embodiment, the water stop material 6B is filled in the outlet 3B between the communicating hole 37B and the communicating hole 38B. The inner walls of the communicating holes 37B and 38B are also filled with the water stop material 6.

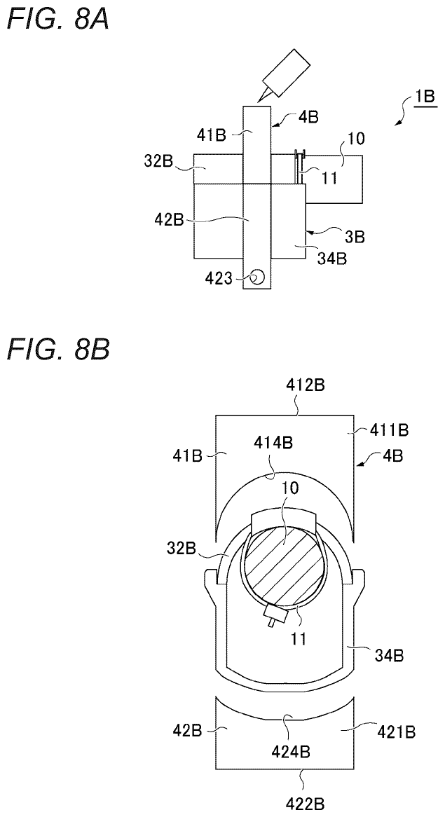

Next, a water stop material filling method for filling the outlet 3B of the electric junction box 1B with the water stop material 6B will be described with reference to FIGS. 8A and 8B. First, as shown in FIG. 8A, the operator attaches the filling portion 4B provided as a separate member so as to cover the communicating holes 37B and 38B of the outlet 3B. The filling portion 4B according to the second embodiment is different from the filling portion 4 according to the first embodiment in that the filling portion 4B is provided as a separate component from the outlet 3B. The filling portion 4B has the same configuration as the filling portion 4 according to the first embodiment except that the filling portion 4B is provided as a separate component from the outlet 3B.

As shown in FIG. 8B, similarly to the first embodiment, the filling portion 4B includes a first filling portion 41B and a second filling portion 42B. Similarly to the first embodiment, the first filling portion 41B includes a rectangular tubular peripheral wall 411B and an upper wall 412B that covers the upper opening of the peripheral wall 411B. A cutout 414B into which the first outlet 32B is fitted is formed in each of the lower ends of the front wall and the rear wall that constitute the peripheral wall 411B and that face each other in the front-rear direction. Similarly to the first embodiment, the upper wall 412B is formed with the inlet 413 (not shown in FIGS. 8A and 8B).

Similarly to the first embodiment, the second filling portion 42B includes a rectangular tubular peripheral wall 421B and a lower wall 422B that covers the lower opening of the peripheral wall 421B. Cutouts 424B into which the second outlet 34B is fitted are formed at the upper ends of the front wall and the rear wall that constitute the peripheral wall 421B and that face each other in the front-rear direction. When the first filling portion 41B is attached to the first outlet 32B and the second filling portion 42B is attached to the second outlet 34B, the lower end of the peripheral wall 411B and the upper end of the peripheral wall 421B are joined together. Similarly to the first embodiment, the peripheral wall 421B is formed with the outlet 423 (see FIG. 8A).

Next, as shown in FIG. 8B, the operator pours the water stop material 6B through the inlet 413 formed in the first filling portion 41B. The water stop material 6B enters the outlet 3B through the communicating hole 37B. The water stop material 6B enters the second filling portion 42B through the communicating hole 38B. When the filling portion 4B and the portion of the outlet 3B surrounded by the filling portion 4B are filled with the water stop material 6B, the water stop material 6B comes out from the outlet 423. When the operator visually recognizes that the water stop material 6B comes out from the outlet 423, the operator stops pouring the water stop material 6B. Thereafter, as shown in FIG. 8B, the operator removes the filling portion 4B and removes the water stop material 6B provided outside the outlet 3B.

According to the second embodiment, the water stop material 6B can be filled over the entire circumference of the wire harness 10 as shown in FIG. 7 without providing the filling portion 4B surrounding the outlet 3B in the electric junction box 1B, and the waterproofness can be improved.

### Third Embodiment

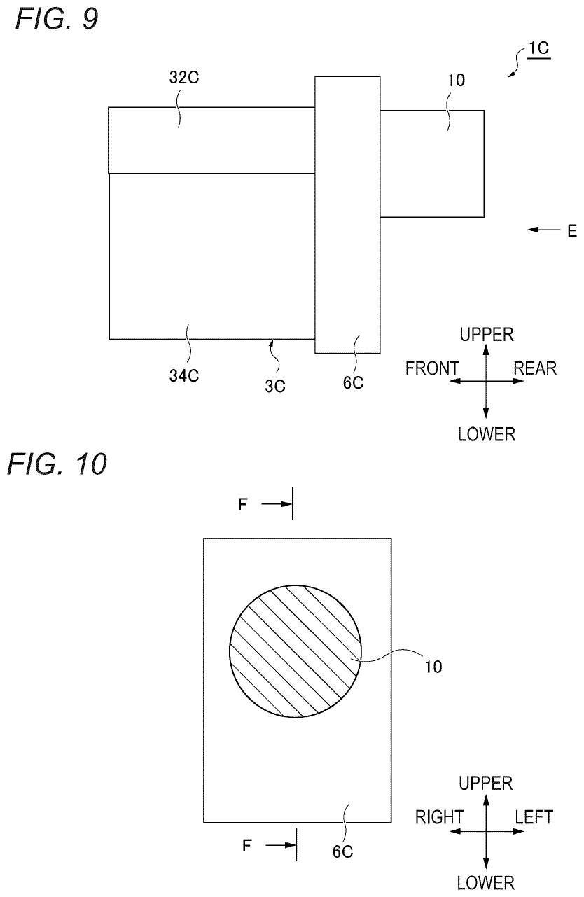

Next, a third embodiment will be described with reference to FIGS. 9 to 11. In FIGS. 9 to 11, the same reference signs are given to the same parts as those of the electric junction box 1B already described in the second embodiment described above, and the detailed description thereof will be omitted. An electric junction box 1C according to the third embodiment includes the electric junction box body 2 (not shown in FIGS. 9 to 11), an outlet 3C, and a water stop material 6C. A difference between the second embodiment and the third embodiment is the configuration of the outlet 3C and the filling position of the water stop material 6C.

Since the electric junction box body 2 is the same as that in the second embodiment, the detailed description thereof is omitted here. As shown in FIGS. 9 to 11, the outlet 3C according to the third embodiment includes a first outlet 32C that is formed in the frame 21, and a second outlet 34C that is formed in the lower cover 23. Similarly to the first embodiment, the first outlet 32C is provided with the pair of cutouts 35 (not shown in FIGS. 9 to 11) and the fixing portion 36. The wire harness 10 is fixed to the fixing portion 36 by the binding band 11.

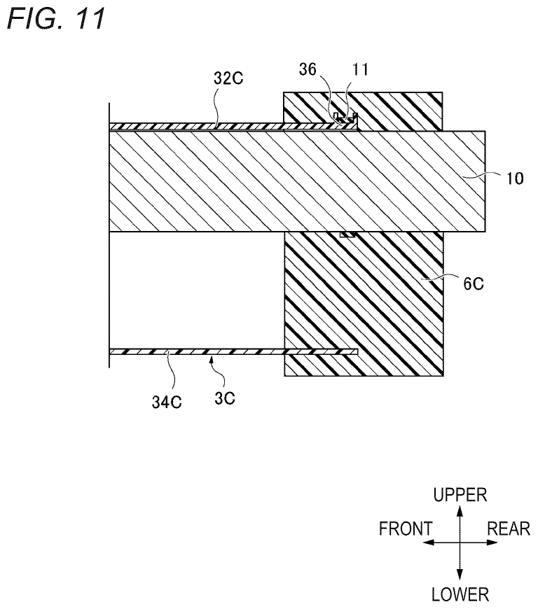

The outlet 3C according to the third embodiment is different from the outlet 3B according to the second embodiment in that the outlet 3C is not formed with the communicating holes 37B and 38B. As shown in FIG. 11, the water stop material 6C surrounds the distal end of the outlet 3C and the wire harness 10 pulled out from the distal end.

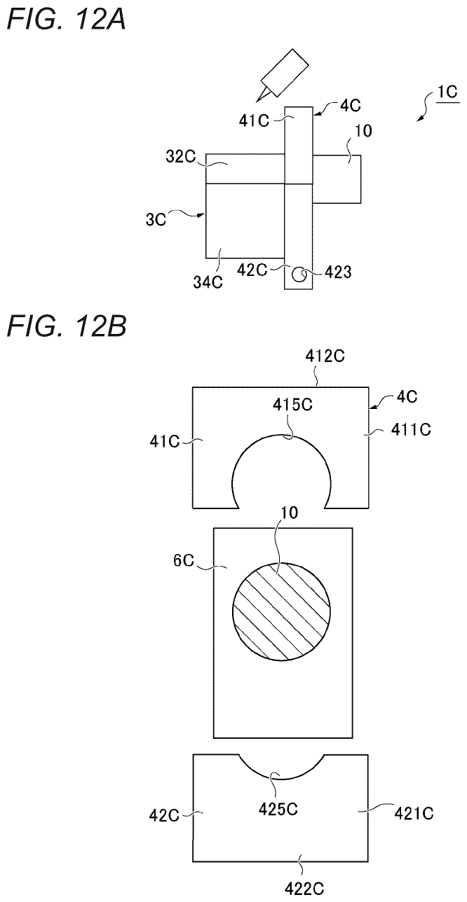

Next, a water stop material filling method for filling the outlet 3C of the electric junction box 1C with the water stop material 6C will be described with reference to FIGS. 12A and 12B. First, as shown in FIG. 12A, the operator attaches the filling portion 4C provided as a separate member so as to surround the distal end of the outlet 3C and the wire harness 10 pulled out from the distal end.

As shown in FIG. 12B, similarly to the first embodiment, the filling portion 4C includes a first filling portion 41C and a second filling portion 42C. Similarly to the first embodiment, the first filling portion 41C includes a rectangular tubular peripheral wall 411C and an upper wall 412C that covers the upper opening of the peripheral wall 411C. The peripheral wall 411C includes a front wall and a rear wall that face each other in the front-rear direction. A cutout (not shown in FIGS. 12A and 12B) into which the first outlet 32C is fitted is formed at the lower end of the front wall. A cutout 415C into which the wire harness 10 is fitted is formed at the lower end of the rear wall. Similarly to the first embodiment, the upper wall 412C is formed with the inlet 413 (not shown in FIGS. 12A and 12B).

Similarly to the first embodiment, the second filling portion 42C includes a rectangular tubular peripheral wall 421C and a lower wall 422C that covers the lower opening of the peripheral wall 421C. The peripheral wall 421C includes a front wall and a rear wall that face each other in the front-rear direction. A cutout (not shown in FIGS. 12A and 12B) into which the second outlet 34C is fitted is formed at the upper end of the front wall. A cutout 425C into which the wire harness 10 is fitted is formed at the lower end of the rear wall. When the first filling portion 41C is attached to the first outlet 32C and the second filling portion 42C is attached to the second outlet 34C, the lower end of the peripheral wall 411C and the upper end of the peripheral wall 421C are joined together. Similarly to the first embodiment, the peripheral wall 421C is formed with the outlet 423 (see FIG. 8A).

Next, the operator pours the water stop material 6C through the inlet 413 formed in the first filling portion 41. As shown in FIG. 11, the water stop material 6C enters the inside of the outlet 3C from the distal end of the outlet 3C. When the filling portion 4 is filled with the water stop material 6C, the water stop material 6C comes out from the outlet 423. When the operator visually recognizes that the water stop material 6C comes out from the outlet 423, the operator stops pouring the water stop material 6C. Thereafter, as shown in FIG. 12B, the operator removes the filling portion 4C.

According to the third embodiment, as shown in FIG. 11, even when there is only a small gap between the wire harness 10 and the first outlet 32C and it is difficult to fill the gap with the water stop material 6C, the rear side (the distal end side of the outlet 3C) of the gap can be covered with the water stop material 6C. Therefore, the water stop material 6C can be filled over the entire circumference of the wire harness 10, and the waterproofness can be improved.

### Fourth Embodiment

Next, a water stop material filling method according to a fourth embodiment will be described. In the first and second embodiments, the first filling portions 41 and 41B face upward, the second filling portions 42 and 42B face downward, and the water stop materials 6 and 6B are poured from the inlet 413 formed in the first filling portions 41 and 41B. When the liquid or gel-shaped water stop materials 6 and 6B that take time to harden are used as the water stop materials 6 and 6B instead of foamed resin that hardens quickly, the water stop materials 6 and 6B may flow into the electric junction box body 2.

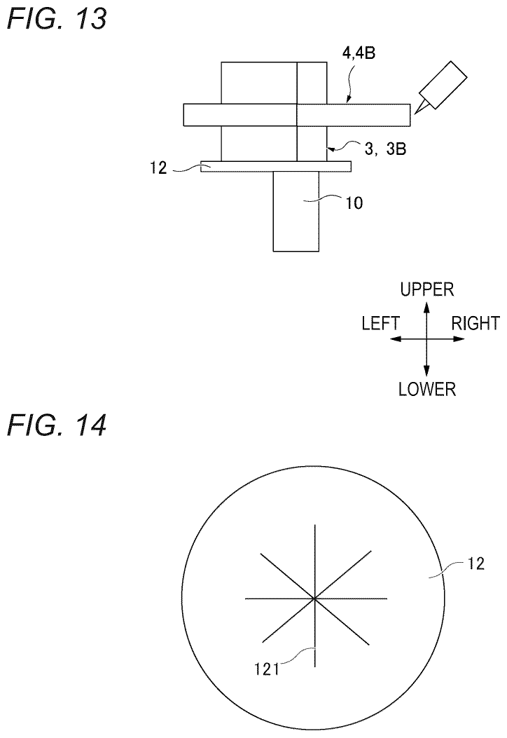

Therefore, in the fourth embodiment, as shown in FIG. 13, the wire harness 10 pulled out from the outlets 3 and 3B is passed through, and a plate-shaped closing member 12 that closes the distal end openings of the outlets 3 and 3B is attached to the wire harness 10.

Thereafter, the water stop materials 6 and 6B are poured into the filling portions 4 and 4B in a state in which the distal ends of the outlets 3 and 3B face vertically downward. The closing member 12 prevents the water stop material from flowing out of the distal end openings of the outlets 3 and 3B, and the water stop material accumulates on the closing member 12. The water stop materials 6 and 6B are poured until the water stop materials 6 and 6B are filled up to the filling portions 4 and 4B.

According to the embodiment described above, since the water stop materials 6 and 6B are poured into the filling portions 4 and 4B in a state in which the distal ends of the outlets 3 and 3B face vertically downward, even when the flowable liquid or gel-shaped water stop materials 6 and 6B are used, there is no risk of the water stop materials 6 and 6B flowing into the electric junction box body 2.

The closing member 12 may be made of an elastic member such as rubber. As a shape of the closing member 12, as shown in FIG. 14, it is conceivable that the closing member 12 is formed in a disk shape and a plurality of notches 121 for passing the wire harness 10 therethrough are formed at the center.

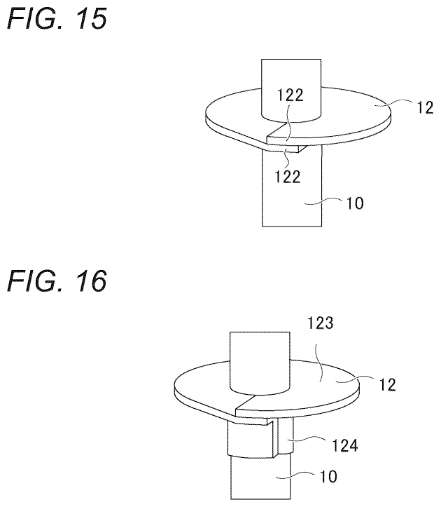

As a shape of the closing member 12, as shown in FIG. 15, the closing member 12 is formed in a ring shape, a part of which is formed with a notch. After the wire harness 10 is inserted into the ring through the notch formed between end portions 122 and 122 of the closing member 12, the end portions 122 and 122 overlap each other in the longitudinal direction of the wire harness 10. Since the inner diameter of the ring can be changed by adjusting the length of the overlapping portion, the ring can be used for the wire harnesses 10 having various diameters.

The shape of the closing member 12 may be formed as shown in FIG. 16. The closing member 12 includes a ring-shaped flange portion 123 that is partially formed with a notch, and a standing wall 124 that stands from the inner edge of the flange portion 123. After the wire harness 10 is inserted into the closing member 12 through the notch formed between end portions 125 and 125 of the closing member 12, the end portions 125 and 125 overlap each other. At this time, the flange portion 123 protrudes in the radial direction of the wire harness 10, and the standing wall 124 overlaps the wire harness 10. The end portions 125 and 125 of the flange portion 123 overlap in the longitudinal direction of the wire harness 10, and the end portions 125 and 125 of the standing wall 124 overlap in the radial direction of the wire harness 10. Since the inner diameters of the flange portion 123 and the standing wall 124 can be changed by adjusting the lengths of the overlapping portions, the flange portion 123 and the standing wall 124 can be used for the wire harnesses 10 having various diameters.

The closing member 12 described above may be removed from the wire harness 10 after the water stop materials 6 and 6B harden.

The present disclosure is not limited to the embodiments described above, and can be appropriately modified, improved, or the like. In addition, the materials, shapes, sizes, numbers, arrangement positions and the like of the components in the embodiments described above are freely selected and are not limited as long as the present disclosure can be implemented.

In the second embodiment described above, the filling portion 4B is provided as a separate component from the outlet 3B, but the present disclosure is not limited thereto. Similarly to the first embodiment, the filling portion 4B may be provided integrally with the outlet 3B, and the filling portion 4B may be removed after the water stop material 6B is filled therein and the water stop material 6B hardens.

In the third embodiment described above, the first filling portion 41C faces upward, the second filling portion 42C faces downward, and the water stop material 6C is poured from the inlet 413 formed in the first filling portion 41C, but the present disclosure is not limited thereto. Similarly to the fourth embodiment, the water stop material 6C may be poured with the distal end of the outlet 3C facing downward.

According to the first to third embodiments described above, the inlet 413 and the outlet 423 are formed in the filling portions 4, 4B and 4C, but it is not essential to form the outlet 423, and the inlet 413 may be formed alone.

Here, the characteristics of the embodiments of the water stop material filling method and the electric junction box according to the present disclosure described above will be briefly summarized and listed below.

A water stop material filling method for filling a water stop material (6, 6B, 6C) into an outlet (3, 3B, 3C) of an electric wire (10) provided in an electric junction box (1, 1B, 1C), the water stop material filling method including:
a step of pouring the water stop material (6, 6B, 6C) through a first hole (413) that is formed in a hollow filling portion (4, 4B, 4C) surrounding an outside of the outlet (3, 3B, 3C) and communicating with the outlet (3, 3B, 3C).

With the above configuration, the water stop material (6, 6B, 6C) is poured through the first hole (413) formed in the hollow filling portion (4, 4B, 4C) surrounding the outside of the outlet (3, 3B, 3C) and communicating with the outlet (3, 3B, 3C). Accordingly, the water stop material (6, 6B, 6C) can be filled over the entire circumference of the electric wire (10), and the waterproofness can be improved.

The water stop material filling method,
in which the outlet (3, 3B, 3C) is provided with a fixing portion (36) to which the electric wire (10) is fixed by a binding band (11), and
in which the filling portion (4, 4B, 4C) is provided on a side that is farther from a distal end of the outlet (3, 3B, 3C) than is the fixing portion (36).

With the above configuration, even if the gap between the fixing portion (36) and the electric wire (10) is small, the water stop material (6, 6B, 6C) can be filled over the entire circumference of the electric wire (10) on the side that is farther from the distal end than is the fixing portion (36), and the waterproofness can be improved.

The water stop material filling method,
in which the filling portion (4C) is provided from a distal end of the outlet (3C) to the electric wire (10) that is pulled out from the distal end.

With the above configuration, even when there is only a small gap between the electric wire (10) and the outlet (3C) and it is difficult to fill the gap with the water stop material (6C), the distal end side (the rear side) of the outlet (3C) of the gap can be covered with the water stop material (6C). Therefore, the water stop material (6C) can be filled over the entire circumference of the electric wire (10), and the waterproofness can be improved.

The water stop material filling method according to [1], further including
a step of removing the filling portion (4, 4B, 4C) after the water stop material (6, 6B, 6C) hardens.

With the above configuration, the filling portion (4, 4B, 4C) can be removed from the electric junction box (1, 1B, 1C).

The water stop material filling method, further including
a step of passing the electric wire (10) pulled out from the outlet (3, 3B) and attaching a closing member (12) configured to close a distal end opening of the outlet (3, 3B), in which after the closing member (12) is attached, in the step of pouring the water stop material (6, 6B), the water stop material (6, 6B) is poured in a state in which a distal end of the outlet (3, 3B) faces vertically downward.

With the above configuration, the water stop material (6, 6B) can be prevented from entering the electric junction box body (2).

An electric junction box (1) including:
an electric junction box body (2) configured to accommodate an electronic component;
an outlet (3) through which an electric wire (10) connected to the electronic component is pulled out from the electric junction box body (2);
a hollow filling portion (4) that surrounds an outside of the outlet (3) and that communicates with the outlet (3); and
a water stop material (6) that is filled in the filling portion (4) and a portion of the outlet (3) surrounded by the filling portion (4),
in which the filling portion (4) is formed with a first hole (413) through which the water stop material (6) is poured.

With the above configuration, the water stop material (6) can be filled over the entire circumference of the electric wire (10), and the waterproofness can be improved.

An electric junction box (1B) including:
an electric junction box body (2) configured to accommodate an electronic component; and
an outlet (3B) through which an electric wire (10) connected to the electronic component is pulled out from the electric junction box body (2),
in which the outlet (3B) is provided with a fixing portion (36) to which the electric wire (10) is fixed by a binding band (11),
the electric junction box (1B) further including:
a water stop material (6B) filled in the outlet (3B) on a side (a rear side) that is farther from a distal end of the outlet (3B) than is the fixing portion (36); and
a second hole (37B) that is formed at the outlet (3B) and through which the water stop material (6B) is poured.

With the above configuration, the water stop material (6B) can be filled over the entire circumference of the electric wire (10), and the waterproofness can be improved.

An electric junction box (1C) including:
an electric junction box body (2) configured to accommodate an electronic component;
an outlet (3C) through which an electric wire (10) connected to the electronic component is pulled out from the electric junction box body (2); and
a water stop material (6C) that surrounds a distal end of the outlet (3C) and the electric wire (10) pulled out from the distal end.

With the above configuration, the water stop material (6C) can be filled over the entire circumference of the electric wire (10), and the waterproofness can be improved.

What is claimed is:

1. A water stop material filling method for filling a water stop material into an outlet of an electric wire provided in an electric junction box, the water stop material filling method comprising:
pouring the water stop material through a first hole that is formed in a hollow filling portion surrounding an outside of the outlet and communicating with the outlet.

2. The water stop material filling method according to claim 1,
wherein the outlet is provided with a fixing portion to which the electric wire is fixed by a binding band, and
wherein the filling portion is provided on a side that is farther from a distal end of the outlet than is the fixing portion.

3. The water stop material filling method according to claim 1,
wherein the filling portion is provided from a distal end of the outlet to the electric wire that is pulled out from the distal end.

4. The water stop material filling method according to claim 1, further comprising
removing the filling portion after the water stop material hardens.

5. The water stop material filling method according to claim 1, further comprising
passing the electric wire pulled out from the outlet and attaching a closing member configured to close a distal end opening of the outlet,
wherein after the closing member is attached, in a step of pouring the water stop material, the water stop material is poured in a state in which a distal end of the outlet faces vertically downward.

6. An electric junction box comprising:
an electric junction box body configured to accommodate an electronic component;
an outlet through which an electric wire connected to the electronic component is pulled out from the electric junction box body;
a hollow filling portion that surrounds an outside of the outlet and that communicates with the outlet; and
a water stop material that is filled in the filling portion and a portion of the outlet surrounded by the filling portion,
wherein the filling portion is formed with a first hole through which the water stop material is poured.

7. An electric junction box comprising:
an electric junction box body configured to accommodate an electronic component; and
an outlet through which an electric wire connected to the electronic component is pulled out from the electric junction box body,
wherein the outlet is provided with a fixing portion to which the electric wire is fixed by a binding band,
wherein the electric junction box further includes:
a water stop material filled in the outlet on a side that is farther from a distal end of the outlet than is the fixing portion; and
a second hole that is formed at the outlet and through which the water stop material is poured.

8. An electric junction box comprising:
an electric junction box body configured to accommodate an electronic component;
an outlet through which an electric wire connected to the electronic component is pulled out from the electric junction box body; and
a water stop material that surrounds a distal end of the outlet and the electric wire pulled out from the distal end.
